(19) United States
(12) Patent Application Publication
(10) Pub. No.: US 2013/0261811 A1
(43) Pub. Date: Oct. 3, 2013

(54) ELECTRONIC APPARATUS AND VIBRATING METHOD

(71) Applicant: NIKON CORPORATION, Tokyo (JP)

(72) Inventors: Takeshi YAGI, Tokyo (JP); Satoru SANADA, Chigasaki-shi (JP)

(21) Appl. No.: 13/909,451

(22) Filed: Jun. 4, 2013

Related U.S. Application Data
(63) Continuation of application No. PCT/JP2011/077057, filed on Nov. 24, 2011.

(30) Foreign Application Priority Data
Dec. 10, 2010 (JP) 2010-276196
Oct. 25, 2011 (JP) 2011-233977

(51) Int. Cl. G05D 19/02

(52) U.S. Cl. CPC G05D 19/02
USPC 700/280

(57) ABSTRACT

A portable terminal apparatus (electronic apparatus) includes a plurality of vibration devices, disposed at different positions, which generate vibrations, and a control unit that independently controls frequencies or strengths of the vibrations generated by the plurality of vibration devices for each of the vibration devices.

### CROSS-REFERENCE TO RELATED APPLICATION

This is a Continuation Application of International Application No. PCT/JP2011/077057, filed on Nov. 24, 2011, which claims priority to Japanese Patent Application Nos. 2010-276196, filed Dec. 10, 2010, and 2011-233977, filed Oct. 25, 2011, the contents of which are incorporated herein by reference.

### BACKGROUND

1. Field of the Invention

The present invention relates to an electronic apparatus and a vibrating method.

2. Description of the Related Art

Conventionally, vibration devices (vibrators) which cause apparatuses to vibrate have been mounted to cellular phones and the like, in order to inform users (persons who carry the phones) of incoming calls and the like through means other than sound or display.

As vibration devices, a cylinder-type or coin-type eccentric motor, a linear vibration actuator (for example, Japanese Unexamined Patent Application, First Publication No. 2006-7161) and the like are used. In these vibration devices, generally, a rated vibration frequency of approximately 150 Hz is widely used in consideration of the characteristics of the human sense of touch.

### SUMMARY

Incidentally, in these vibration devices, a force generated by vibrations is remarkably weakened in a frequency separate from a rated frequency (resonance frequency in a case of a linear vibration actuator). On the other hand, even when a vibration frequency is changed in the vicinity of a rated frequency (resonance frequency) having approximately several hertz, a force generated by vibrations does not attenuate greatly.

However, it is very difficult for a user to perceive a difference (for example, difference between 148 Hz and 152 Hz) in the frequency. For this reason, a user can obviously make a distinction between the presence and absence of a vibration, but has a difficulty in perceiving the type of vibrations caused by the frequency.

As stated above, in the vibration devices of the related art, individual vibrations cannot be allocated to multiple types of notification events (for example, incoming call, data reception, alarm, and the like) of a cellular phone and the like. For this reason, when a notification through vibrations is given, a user has to confirm content displayed on a terminal in order to know the details thereof.

An aspect of the present invention aims at providing an electronic apparatus and a vibrating method which are capable of generating vibrations having multiple types of frequencies which are perceivable by a user.

According to one aspect of the present invention, an electronic apparatus is provided, including: a plurality of vibrators, disposed at different positions, which generate vibrations; and a control unit that independently controls frequencies or strengths of the vibrations generated by the plurality of vibrators for each of the vibrators.

According to the aspect of the present invention, it is possible to generate vibrations having multiple types of frequencies which are perceivable by a user.

### BRIEF DESCRIPTION OF DRAWINGS

FIG. 1 is a block diagram illustrating a configuration of a portable terminal apparatus according to a first embodiment.

FIG. 2 is a block diagram illustrating a configuration of a vibration signal generation unit according to the first embodiment.

FIG. 3A is a schematic diagram illustrating arrangement positions of vibration devices according to the first embodiment.

FIG. 3B is a schematic diagram illustrating the arrangement positions of the vibration devices according to the first embodiment.

FIG. 4 is a schematic diagram illustrating a data structure and a data example of a notification event table according to the first embodiment.

FIG. 5 is a schematic diagram illustrating a data structure and a data example of a vibration pattern table according to the first embodiment,

FIG. 6 is a flow diagram illustrating a procedure of a vibration generation process according to the first embodiment.

FIG. 7 is a graph illustrating an example of a heat vibration according to the first embodiment.

FIG. 8 is a flow diagram illustrating a procedure of a vibration pattern registration process according to the first embodiment.

FIG. 9A is an image diagram of a vibration generated by a portable terminal apparatus according to a second embodiment.

FIG. 9B is an image diagram of a vibration generated by the portable terminal apparatus according to the second embodiment.

FIG. 9C is an image diagram of a vibration generated by the portable terminal apparatus according to the second embodiment.

FIG. 10A is a schematic diagram illustrating an example of a structure having different resonance frequencies depending on location according to a third embodiment.

FIG. 10B is a schematic diagram illustrating an example of a structure having different resonance frequencies depending on location according to the third embodiment.

FIG. 11 is a schematic diagram illustrating arrangement positions of the vibration devices when the vibration devices are disposed at the four corners of the portable terminal apparatus.

### DESCRIPTION OF EMBODIMENTS

Hereinafter, embodiments of the present invention will be described in detail with reference to the accompanying drawings.

### First Embodiment

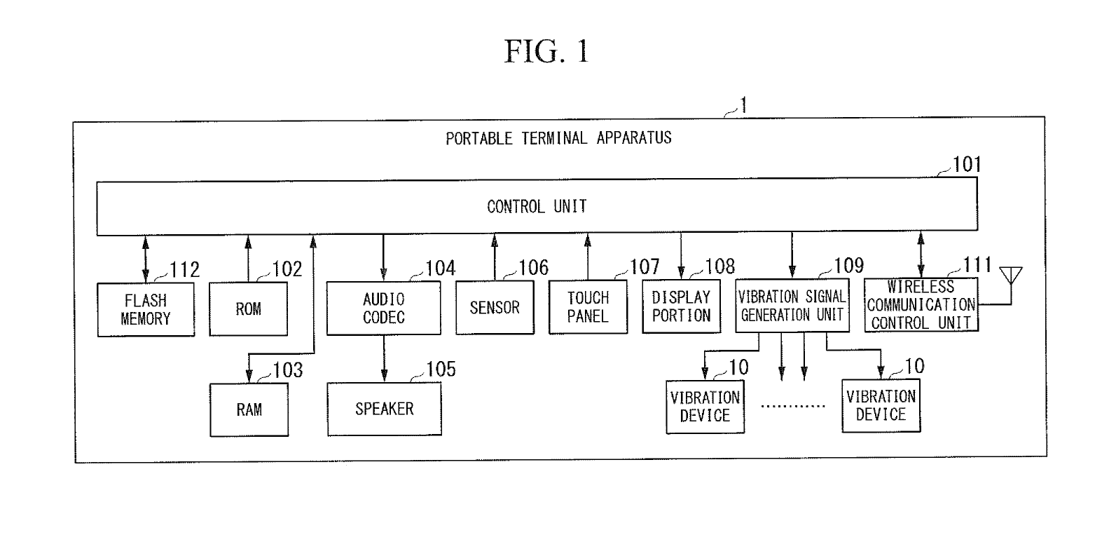

FIG. 1 is a block diagram illustrating a configuration of a portable terminal apparatus 1 according to the present embodiment,

The portable terminal apparatus 1 is, for example, an electronic apparatus such as a cellular phone, a PDA (Personal Digital Assistant), a smart phone, a game console, and a digital camera. As shown in the drawing, the portable terminal apparatus 1 is configured to include a control unit 101, a ROM (Read Only Memory) 102, a RAM (Random Access Memory) 103, an audio codec 104, a speaker 105, a sensor 106, a touch panel 107, a display portion 108, a vibration signal generation unit 109, a plurality of vibration devices 10, a wireless communication control unit 111, and a flash memory 112.

The control unit 101 is a CPU (Central Processing Unit) and a peripheral interface, and controls the portable terminal apparatus 1 as a whole. The control unit 101 independently controls the frequencies or strengths of vibrations generated by a plurality of vibration devices 10 for each of the vibration devices 10. Here, the control unit 101 causes at least two vibration devices 10 to vibrate simultaneously, and independently controls the frequency or strength of the vibration generated by each of the vibration devices 10 which are caused to vibrate. Specifically, the control unit 101 causes each of two or more of the vibration devices 10 to vibrate simultaneously at a different frequency. At this time, the control unit 101 selects one or a plurality of vibration devices 10 in accordance with a notification event to a user, and causes the selected vibration devices 10 to vibrate simultaneously.

The ROM 102 is a read-only memory that stores a program or the like for controlling the portable terminal apparatus 1. The RAM 103 is an occasional read/write memory that stores various pieces of information.

The audio codec 104 decodes input audio data, and converts the decoded digital audio data to analog data to output the converted data to the speaker 105. The speaker 105 outputs audio which is input from the audio codec 104.

The sensor 106 is configured to include a motion sensor and a GPS (Global Positioning System). The motion sensor is configured to include an acceleration sensor that detects acceleration and an angular velocity sensor that detects angular velocity. The touch panel 107, installed on the display portion 108, senses the contact of an object, and outputs a position at which the contact is sensed to the control unit 101. The display portion 108 is a display such as an LCD (Liquid Crystal Display). The vibration signal generation unit 109 causes the vibration device 10 to vibrate in response to a signal from the control unit 101. The vibration device 10 is a linear vibration actuator having a prescribed frequency (resonance frequency). In the present embodiment, a case where a resonance frequency f0 of the vibration device 10 is 150 Hz will be described by way of example.

The wireless communication control unit 111 performs wireless communication with another portable terminal apparatus 1 through an antenna. The flash memory (storage unit) 112 is a writeable nonvolatile memory, and stores a notification event table and a vibration pattern table which are described later.

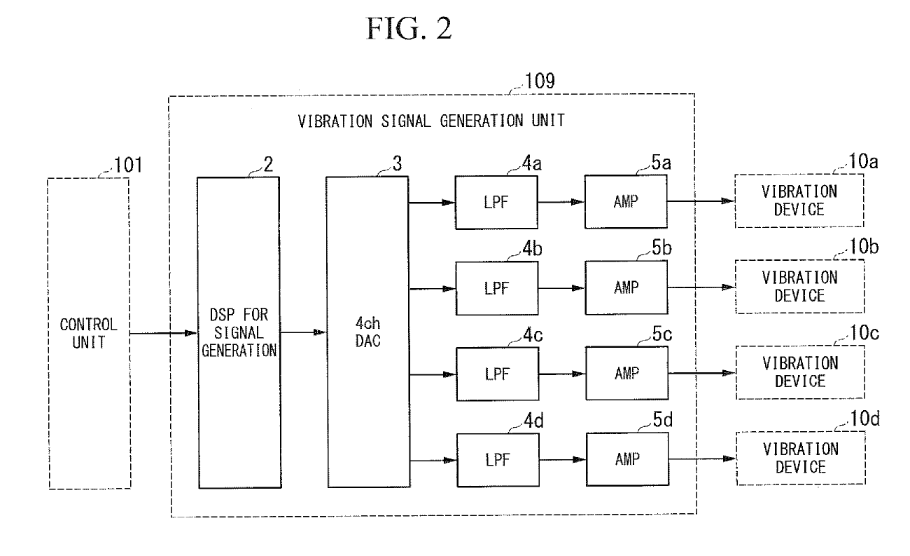

FIG. 2 is a block diagram illustrating a configuration of the vibration signal generation unit 109 according to the present embodiment.

The vibration signal generation unit 109 is configured to include a DSP (Digital Signal Processor) 2 for signal generation, a DAC (Digital-to-Analog Converter) 3, LPFs (Low-Pass Filters) 4a to 4d and AMPs (AMPlifiers) 5a to 5d which correspond to each of the vibration devices 10.

Hereinafter, for convenience of description, four vibration devices 10 included in the portable terminal apparatus 1 are respectively allocated signs of a to d, and are expressed as vibration devices 10a, 10b, 10c, and 10d. Meanwhile, regarding items common to each of the vibration devices 10a to 10d, signs of a to d will be omitted, and the items are simply expressed as “vibration device 10” or “each of the vibration devices 10”.

When a control signal is input from the control unit 101, the DSP 2 for signal generation produces a sinusoidal wave for each channel of the vibration device 10 based on the input control signal, and outputs the produced wave to the DAC 3. The control signal is a signal for controlling the vibration device 10, and is a start signal for instructing the start of a vibration or a stop signal for instructing the stop of a vibration. The start signal includes information indicating the channel of the vibration device 10 that starts a vibration, the vibration strength of the vibration device 10 that starts a vibration, the vibration frequency of the vibration device 10 that starts a vibration, and the like. In addition, the stop signal includes information indicating the channel of the vibration device 10 that stops a vibration. The DSP 2 for signal generation according to the present embodiment can output a maximum of 4 channels of sinusoidal waves. In addition, the frequency of the sinusoidal wave produced by the DSP 2 for signal generation is equal to the resonance frequency f0 of the vibration device 10, or is a value very close to the resonance frequency (for example, value equal to or greater than f0−10 Hz and equal to or less than f0+10 Hz, or the like).

The DAC 3 converts the input digital sinusoidal wave into an analog sinusoidal wave and outputs the converted wave to each of the LPFs 4a to 4d. Each of the LPFs 4a to 4d is a low-pass filter corresponding to each of the vibration devices 10, and has a function of removing a high frequency component from the input sinusoidal wave and outputting a sinusoidal wave obtained by removing the high frequency component to each of the corresponding AMPs 5a to 5d. This is because the sinusoidal wave converted into an analog wave by the DAC 3 is mixed with a high frequency component at the time of discrete data conversion. Each of the AMPs 5a to 5d is an audio amplifier for driving each of the vibration devices 10, and has a function of amplifying a sinusoidal wave which is input from each of the LPFs 4a to 4d and outputting the amplified wave to each of the corresponding vibration devices 10a to 10d. Each of the LPFs 4a to 4d and the AMPs 5a to 5d are associated with each of the vibration devices 10a to 10d.

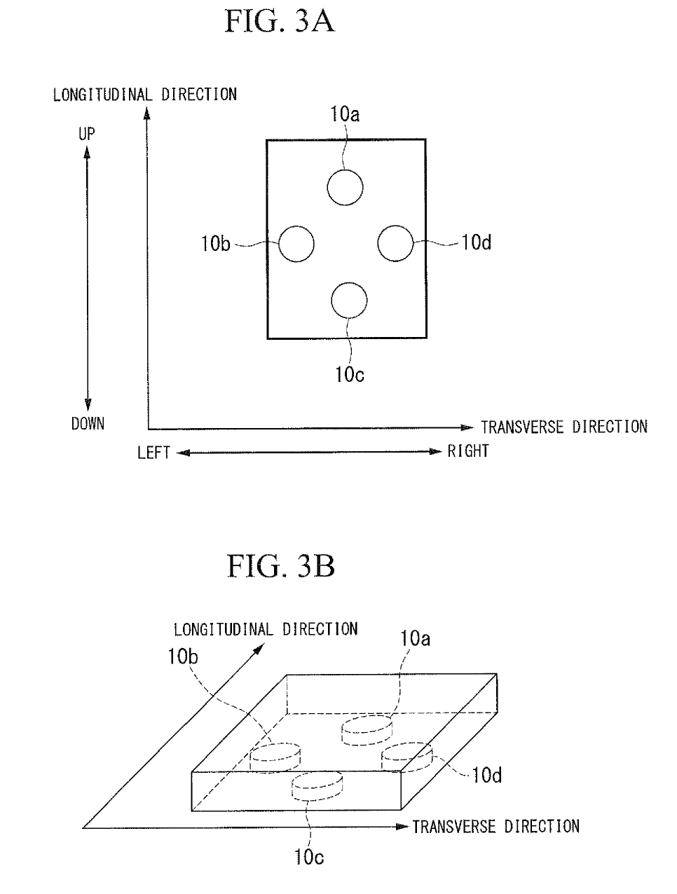

FIG. 3A is a front view of the portable terminal apparatus 1 illustrating the arrangement of the vibration devices 10 according to the present embodiment. In addition, FIG. 3B is a perspective view of the portable terminal apparatus 1 illustrating the arrangement of the vibration devices 10 according to the present embodiment.

Here, in the portable terminal apparatus 1, a predetermined direction (direction toward the vibration device 10a from the vibration device 10c) is set to a longitudinal direction, and a direction perpendicular to the longitudinal direction is set to a transverse direction.

As shown in the drawing, the vibration devices 10 are installed at different positions, respectively. The vibration device 10a is installed at the upper portion of the portable terminal apparatus 1, the vibration device 10b is installed at the left portion of the portable terminal apparatus 1, the vibration device 10c is installed at the lower portion of the portable terminal apparatus 1, and the vibration device 10d is installed at the right portion of the portable terminal apparatus 1.

Next, various types of tables stored by the flash memory 112 will be described.

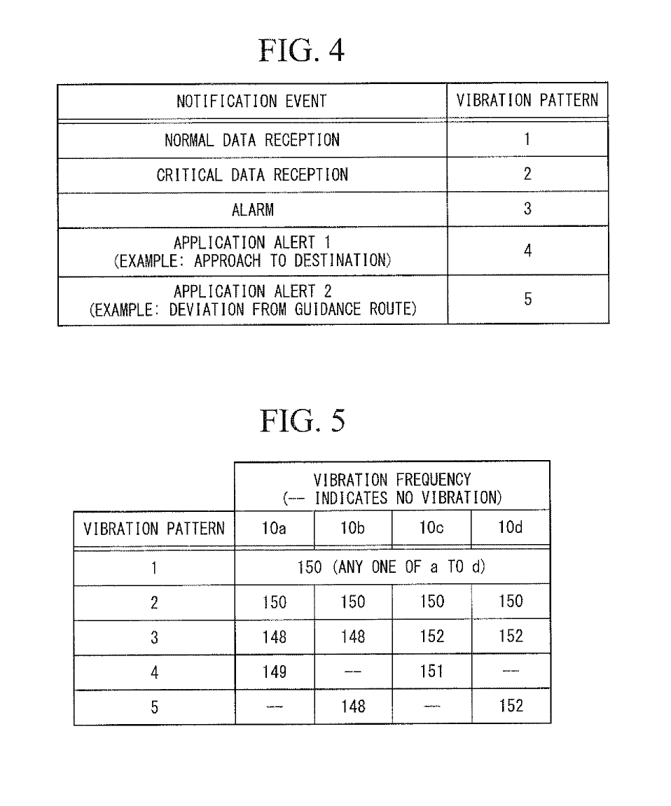

FIG. 4 is a schematic diagram illustrating a data structure and a data example of a notification event table stored by the flash memory 112 according to the present embodiment. As shown in the drawing, the notification event table is two-dimensional tabular data made of rows and columns, and has columns of each item of a notification event and a vibration pattern. Each row of the table is present for each notification event. The notification event is an event (notification event) of which a user of the portable terminal apparatus 1 is notified. The vibration pattern is a number for identifying the type of a vibration. In the example shown in the drawing, the vibration pattern corresponding to normal data reception is “1”, the vibration pattern corresponding to critical data reception is “2”, the vibration pattern corresponding to an alarm is “3”, the vibration pattern corresponding to an application alert 1 is “4”, and the vibration pattern corresponding to an application alert 2 is “5”.

Here, the critical data is data consistent with criteria which are set in advance (for example, a predetermined source, a predetermined data format and the like). In addition, the normal data is data other than the critical data. The alarm is a function such as an alarm clock. In addition, the application alerts 1 and 2 are events associated with predetermined application software (navigation application in the present example). The navigation application in the present example is application software relating to road guidance which is installed in the portable terminal apparatus 1 in advance.

Meanwhile, in the present embodiment, the normal data reception is a first notification event, and the critical data reception, the alarm, the application alert 1, and the application alert 2 are second notification events. However, the first notification event and the second notification event can be set arbitrarily without being limited to such an example.

FIG. 5 is a schematic diagram illustrating a data structure and a data example of a vibration pattern table stored by the flash memory 112 according to the present embodiment. As shown in the drawing, the vibration pattern table is two-dimensional tabular data made of rows and columns, and has a column of each item of the vibration pattern and the vibration frequency of each of the vibration devices 10. Each row of the table is present for each vibration pattern. Here, the vibration frequency of “--” indicates no vibration. In the example shown in the drawing, in the vibration pattern 1, any one of the vibration devices 10a to 10d vibrates at 150 Hz. In addition, in the vibration pattern 2, all the vibration devices 10a to 10d vibrate simultaneously at 150 Hz. In addition, in the vibration pattern 3, the vibration devices 10a and 10b vibrate at 148 Hz, and the vibration devices 10c and 10d vibrate simultaneously at 152 Hz. In addition, in the vibration pattern 4, the vibration device 10a vibrates at 149 Hz, and the vibration device 10c vibrates simultaneously at 151 Hz. In addition, in the vibration pattern 5, the vibration device 10b vibrates at 148 Hz, and the vibration device 10d vibrates simultaneously at 152 Hz.

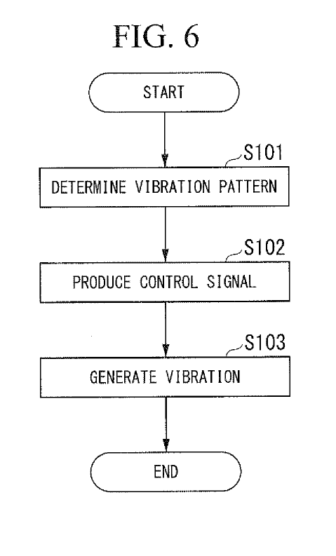

Next, a vibration generation process of the portable terminal apparatus 1 will be described with reference to FIG. 6. FIG. 6 is a flow diagram illustrating a procedure of the vibration generation process according to the present embodiment.

When a notification event is generated in the portable terminal apparatus 1, in step S101, the control unit 101 reads out a vibration pattern corresponding to the generated notification event from the notification event table, and determines the vibration pattern.

Next, in step S102, the control unit 101 reads out the vibration frequency of each of the vibration devices 10 corresponding to the determined vibration pattern from the vibration pattern table, and produces a control signal for generating a vibration. The control unit 101 then outputs the produced control signal to the vibration signal generation unit 109.

Finally, in step S103, the vibration signal generation unit 109 causes each of the vibration devices 10 to vibrate based on the control signal which is input from the control unit 101.

Hereinafter, the vibration generation process will be described by way of specific examples.

1. Normal Data Reception

When the normal data is received through the wireless communication control unit 111, the control unit 101 outputs a control signal corresponding to the vibration pattern 1 to the vibration signal generation unit 109. That is, the control unit 101 outputs a signal for causing any one of the vibration devices 10a to 10d to vibrate at 150 Hz, to the vibration signal generation unit 109. At this time, the control unit 101 changes the vibrating vibration device 10 each time. Specifically, the control unit 101 reads out a history of the vibrating vibration devices 10 which is stored in the RAM 103 in advance, and selects, for example, the vibration device 10 which has not recently vibrated, based on the read out history. The control unit 101 then adds identification information of the selected vibration device 10 to the history and writes the added information in the RAM 103. In this manner, the vibrating vibration device 10 is changed each time in consideration of the mechanical endurance of the vibration device 10, thereby allowing the life span of the vibration devices 10 to be lengthened.

The vibration signal generation unit 109 causes the vibration device 10 selected by the control unit 101 to vibrate at 150 Hz, based on the signal which is input from the control unit 101.

2. Critical Data Reception

When the critical data is received through the wireless communication control unit 11, the control unit 101 outputs a signal corresponding to the vibration pattern 2 to the vibration signal generation unit 109. That is, the control unit 101 outputs signals for causing all the vibration devices 10a to 10d to vibrate simultaneously at 150 Hz, to the vibration signal generation unit 109. The vibration signal generation unit 109 causes all the vibration devices 10a to 10d to vibrate simultaneously at 150 Hz, based on the signals which are input from the control unit 101. Since all the vibration devices 10a to 10d are caused to vibrate, a user can sense that the portable terminal apparatus 1 vibrates more greatly than in a case where any one of the vibration devices 10a to 10d is caused to vibrate.

3. Alarm

When the time which is set in the alarm arrives, the control unit 101 outputs a signal corresponding to the vibration pattern 3 to the vibration signal generation unit 109. That is, the control unit 101 outputs signals for causing the vibration device 10a and the vibration device 10b to vibrate at 148 Hz and causing the vibration device 10e and the vibration device 10d to vibrate simultaneously at 152 Hz, to the vibration signal generation unit 109.

The vibration signal generation unit 109 causes the vibration device 10a and the vibration device 10b to vibrate at 148 Hz, and causes the vibration device 10c and the vibration device 10d to vibrate simultaneously at 152 Hz. Thereby, the portable terminal apparatus 1 generates a beat vibration of 4 Hz.

4. Navigation Application

The control unit 101 executes a navigation application, and thus performs road guidance to a destination for a user of the portable terminal apparatus 1, based on positional information detected by the GPS included in the sensor 106.

When an approach to the destination (indicating that the distance from a position detected by the GPS to the destination is in a predetermined range) is detected, the control unit 101 outputs a signal corresponding to the vibration pattern 4 to the vibration signal generation unit 109. That is, the control unit 101 outputs signals for causing the vibration device 10a to vibrate at 149 Hz and causing the vibration device 10c to vibrate simultaneously at 151 Hz, to the vibration signal generation unit 109. The vibration signal generation unit 109 causes the vibration device 10a to vibrate at 149 Hz, and causes the vibration device 10c to vibrate simultaneously at 151 Hz. Thereby, the portable terminal apparatus 1 generates a beat vibration of 2 Hz in a longitudinal direction.

In addition, when a motion such as deviation from a guidance route (indicating that the position detected by the GPS is away from the guidance route by a predetermined distance or more) is detected, the control unit 101 outputs a signal corresponding to the vibration pattern 5 to the vibration signal generation unit 109. That is, the control unit 101 outputs signals for causing the vibration device 10b to vibrate at 148 Hz and causing the vibration device 10d to vibrate simultaneously at 152 Hz, to the vibration signal generation unit 109. The vibration signal generation unit 109 causes the vibration device 10b to vibrate at 148 Hz, and causes the vibration device 10d to vibrate simultaneously at 152 Hz. Thereby, the portable terminal apparatus 1 generates a beat vibration of 4 Hz in a transverse direction.

Here, since the beat vibrations generated by the portable terminal apparatus 1 in the vibration patterns 3 to 5 have low frequencies, a person can sense a difference between the frequencies. For this reason, a user can identify each of the vibration patterns 1 to 5.

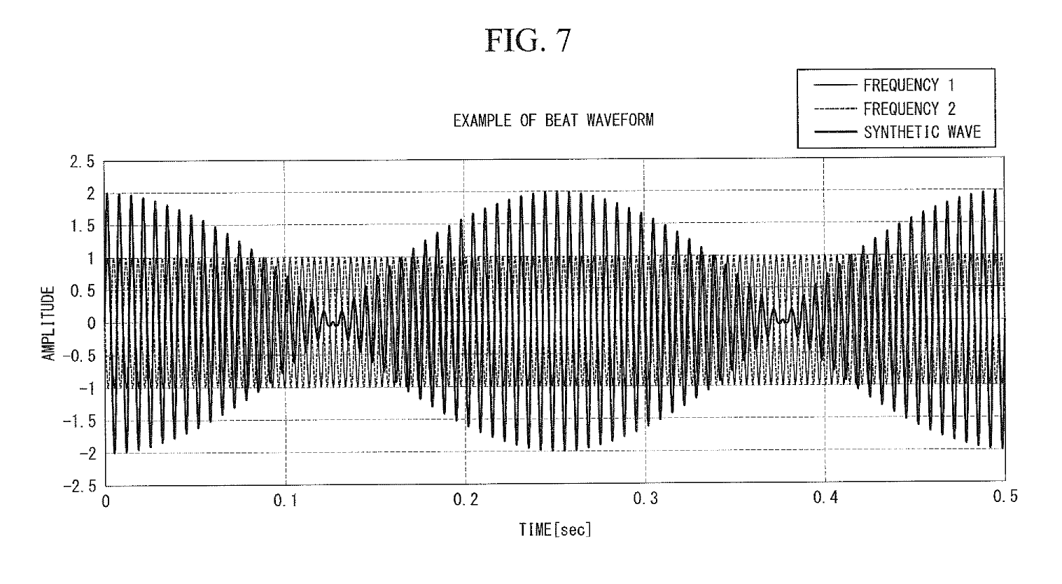

FIG. 7 is a graph illustrating an example of a beat vibration according to the present embodiment.

The horizontal axis of the graph in the drawing is the time, and the vertical axis thereof is the amplitude of a vibration.

As shown in the drawing, when a vibration of 148 Hz (frequency 1) and a vibration of 152 Hz (frequency 2) overlap each other, a beat vibration of low frequency (4 Hz) is generated.

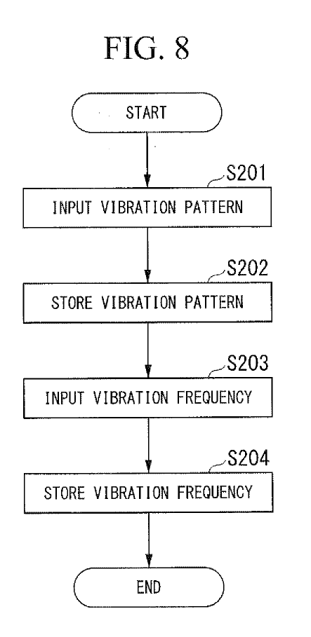

Next, a vibration pattern registration process of the portable terminal apparatus 1 will be described with reference to FIG. 8. FIG. 8 is a flow diagram illustrating a procedure of the vibration pattern registration process according to the present embodiment.

First, in step S201, the touch panel (input unit) 107 accepts an input of the vibration pattern. At this time, the display portion 108 displays a screen for inputting the vibration pattern for each notification event. A user inputs the vibration pattern corresponding to a notification event based on the screen displayed on the display portion 108.

Next, in step S202, the control unit 101 writes the input vibration pattern in the notification event table in association with the notification event.

Next, in step S203, the touch panel 107 accepts an input of the vibration frequency of the vibration device 10 corresponding to the vibration pattern. At this time, the display portion 108 displays a screen for inputting the vibrating vibration device 10 and the vibration frequency of the vibration device 10 for each vibration pattern. A user inputs the vibrating vibration device 10 and the vibration frequency of the vibration device 10 in each vibration pattern, based on the screen displayed on the display portion 108.

Next, in step S204, the control unit 101 writes the vibration frequency of each of the vibration devices 10, which is input, in the vibration pattern table in association with the vibration pattern.

As stated above, in the present embodiment, since beat vibrations of a plurality of frequencies capable of being sensed by a person can be generated, it is possible to allocate a unique vibration for each notification event. Thereby, a user can perceive what type of notification has been made just through a vibration generated in the portable terminal apparatus 1. In addition, since the vibration of only one vibration device 10 may be generated depending on the notification event, it is also possible to suppress power consumption.

In addition, since the vibration pattern can be input for each notification event, a user can customize the vibration pattern corresponding to each notification event.

Meanwhile, when the number of vibrating vibration devices 10 is equal to or less than 3 (the number of vibration devices 10 included in the portable terminal apparatus 1 is smaller than 4), the combination of the vibrating vibration devices 10 may be changed each time or at a predetermined period (for example, once every 3 times or the like). For example, in the vibration pattern 4, it is considered that for the first time, the control unit 101 causes the vibration device 10a to vibrate at 148 Hz and causes the vibration device 10e to vibrate simultaneously at 151 Hz, and for the second time, causes the vibration device 10b to vibrate at 148 Hz and causes the vibration device 10d to vibrate simultaneously at 151 Hz.

In addition, the frequencies of the beat vibrations generated by the portable terminal apparatus 1, such as the beat vibration of 4 Hz generated for the first 5 seconds, the beat vibration of 2 Hz generated for the next 5 seconds, and the beat vibration of 1 Hz generated for the next 5 seconds, may be changed in accordance with the time. Alternatively, the vibration directions of the beat vibrations generated by the portable terminal apparatus 1 may be changed in accordance with the time.

In addition, in the above-mentioned vibration pattern registration process, the vibration frequency of the vibration device 10 corresponding to the vibration pattern is registered. However, for example, the vibration strength thereof may be registered. In this case, in the vibration pattern table, the vibration strength is also stored in addition to the vibration frequency of each of the vibration devices 10.

### Second Embodiment

Next, the portable terminal apparatus 1 according to a second embodiment of the present invention will be described.

The control unit 101 according to the present embodiment vibrates two or more vibration devices 10 simultaneously, and changes the ratio of the strength of a vibration generated by each of the vibration devices 10 together with the time. Other configurations are the same as those of the portable terminal apparatus 1 according to the first embodiment, and thus the description thereof will be omitted.

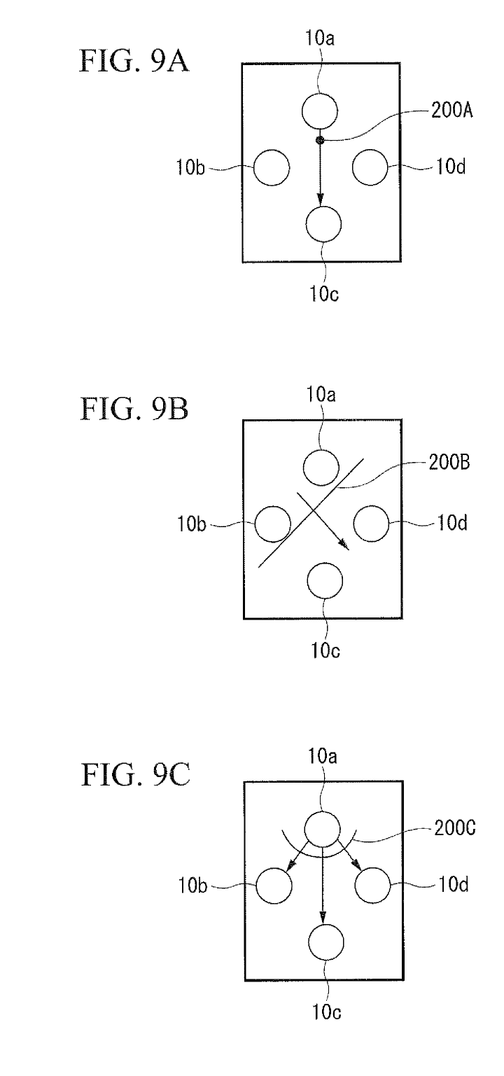

FIGS. 9A to 9C are image diagrams of vibrations generated by the portable terminal apparatus 1 according to the present embodiment.

In the example shown in FIG. 9A, the control unit 101 causes the vibration device 10a and the vibration device 10c to vibrate simultaneously at different strengths. At this time, the frequencies of vibrations generated by the vibration devices 10 and 10c are the same as each other. The control unit 101 changes the strength ratio of the vibration generated by the vibration device 10a to the vibration generated by the vibration device 10b in accordance with the time. Specifically, first, the vibration device 10a is caused to vibrate with strength greater than that of the vibration device 10e. With the elapse of time, the control unit 101 gradually weakens the strength of the vibration generated by the vibration device 10a, and gradually strengthens the strength of the vibration generated by the vibration device 10b. Thereby, a user feels as if a vibration position 200A in the portable terminal apparatus 1 moves from a position of the vibration device 10a to a position of the vibration device 10b.

In addition, in the example shown in FIG. 9B, the control unit 101 causes a set of vibration device 10a and vibration device 10b (hereinafter, referred to as group A) and a set of vibration device 10c and vibration device 10d (hereinafter, referred to as a group B) to vibrate simultaneously at different strengths. At this time, the frequencies of the vibrations generated by each of the vibration devices 10 are the same as each other. The control unit 101 changes the ratio of the strength of the vibration generated by the group A to the strength of the vibration generated by the group B in accordance with the time. Specifically, the control unit 101 causes the group A to first vibrate with strength greater than that of the group B. With the elapse of time, the control unit 101 gradually weakens the strength of the vibration generated by the group A, and gradually strengthens the strength of the vibration generated by the group B. Thereby, a user feels as if a vibration position 200E in the portable terminal apparatus 1 moves from a position of the group A to a position of the group B.

In addition, in the example shown in FIG. 9C, the control unit 101 causes a set of vibration device 10b, vibration device 10c and vibration device 10d (hereinafter, referred to as a group X), and the vibration device 10a to vibrate simultaneously at different strengths. At this time, the frequencies of the vibrations generated by each of the vibration devices 10 are the same as each other. The control unit 101 changes the ratio of the strength of the vibration generated by the vibration device 10a to the strength of the vibration generated by the group X in accordance with the time. Specifically, the control unit 101 causes the vibration device 10a to vibrate with strength greater than that of the group X. With the elapse of time, the control unit 101 gradually weakens the strength of the vibration generated by the vibration device 10a, and gradually strengthens the strength of the vibration generated by the group X. Thereby, a user feels as if a vibration position 200C in the portable terminal apparatus 1 moves in a wave form from a position of the vibration device 10a to a position of the group X.

As stated above, in the present embodiment, a vibration for causing a user to feel as if the vibration position changes can be generated by changing the strength ratio of the vibrations generated by the vibration devices 10 which are caused to vibrate simultaneously.

### Third Embodiment

Next, the portable terminal apparatus 1 according to a third embodiment of the present invention will be described.

The portable terminal apparatus 1 according to the present embodiment has a structure having different resonance frequencies depending on location. The control unit 101 causes the vibration device 10 to vibrate at a resonance frequency depending on a desired location.

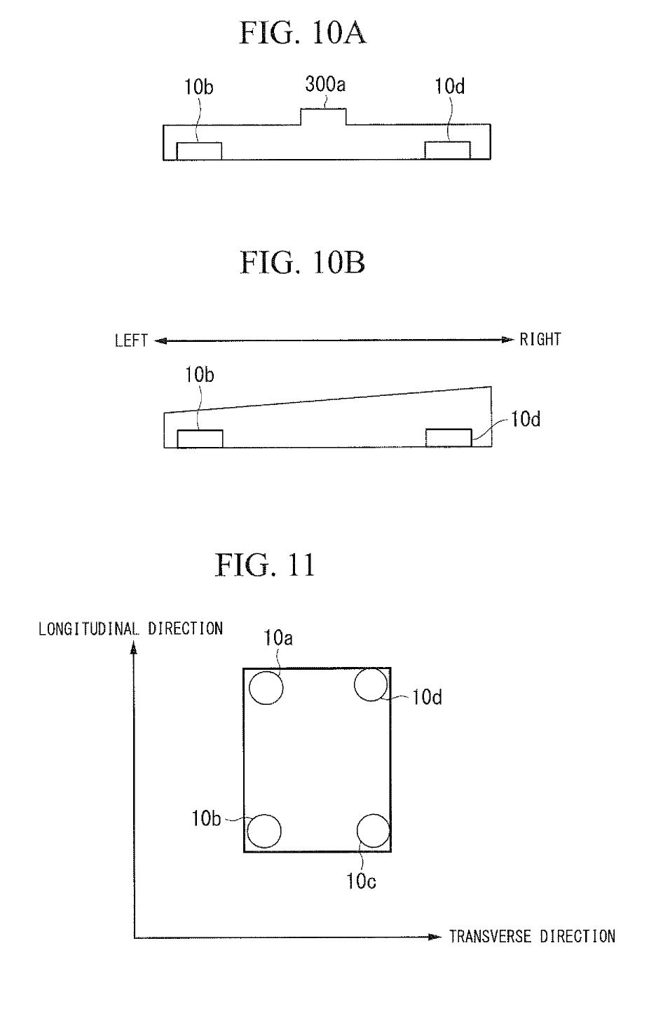

FIGS. 10A and 1013 are schematic diagrams illustrating an example of structures having different resonance frequencies depending on location according to the present embodiment.

In the example shown in FIG. 10A, in the portable terminal apparatus 1, a location 300a located between the vibration device 10b and the vibration device 10d has high rigidity because the thickness thereof is larger than those of other locations. For this reason, the resonance frequency of the location 300a is higher than those of other locations of the portable terminal apparatus 1. Here, a description will be made of a case where the resonance frequency of the location 300a is 160 Hz, and the resonance frequencies of locations other than the location 300a in the portable terminal apparatus 1 are 150 Hz. The control unit 101 causes the vibration device 10b and the vibration device 10d to vibrate simultaneously at 160 Hz. Thereby, a user feels as if the portable terminal apparatus 1 vibrates strongly at the location 300a.

Meanwhile, in the present embodiment, the location 300a is provided with a structure having a resonance frequency different from those of other locations, but an arbitrary location of the portable terminal apparatus 1 may be provided with a structure having a resonance frequency different from those of other locations, without being limited to this example. Alternatively, a plurality of locations may be provided with a structure having a resonance frequency different from those of other locations.

In the example shown in FIG. 10B, the portable terminal apparatus 1 includes a structure in which the thickness changes continuously from the right to the left. Here, the portable terminal apparatus 1 becomes thicker toward the right. That is, the portable terminal apparatus 1 includes a structure in which the resonance frequency changes continuously from side to side. Here, a description will be made of a case where the resonance frequency of the left end in the portable terminal apparatus 1 is 150 Hz, and the resonance point of the right end in the portable terminal apparatus 1 is 160 Hz. The resonance frequency in the portable terminal apparatus 1 changes continuously from side to side, becomes lower toward the left, and becomes higher toward the right. The control unit 101 causes the vibration device 10b and the vibration device 10d to vibrate simultaneously, and gradually changes the vibration frequency from 150 Hz to 160 Hz with the elapse of time. Here, a vibration occurs on the left side of the portable terminal apparatus 1 when the vibration frequency is 150 Hz, and a vibration occurs on the right side of the portable terminal apparatus 1 when the vibration frequency is 160 Hz. As a result, a user feels as if the vibration position in the portable terminal apparatus 1 moves from the right to the left.

Meanwhile, in the present embodiment, a structure in which the thickness changes in a transverse direction is provided, but a structure in which the thickness changes in an arbitrary direction such as, for example, a longitudinal direction may be provided without being limited to this example.

As stated above, in the present embodiment, the portable terminal apparatus 1 includes a structure having different resonance frequencies, and the control unit 101 causes the vibration device 10 to vibrate at a resonance frequency corresponding to a desired location. For this reason, it is possible to generate various types of vibrations.

Meanwhile, in the present embodiment, two of the vibration device 10b and the vibration device 10c are caused to vibrate simultaneously, but another combination of, for example, the vibration device 10a and the vibration device 10d, or the like may be used. Alternatively, one vibration device 10 may be caused to vibrate.

### Fourth Embodiment

Next, a description will be made of a case where the vibration control described with reference to FIG. 9A is applied to a navigation application. In a fourth embodiment, a user employs a navigation application while walking with the portable terminal apparatus 1 in the chest pocket of his/her shirt. Hereinafter, only differences from the first to third embodiments will be described.

The control unit 101 receives acceleration information, angular velocity information, and positional information from the sensor 106. The control unit 101 detects the arrangement (posture in a vertical direction) of the portable terminal apparatus within the chest pocket based on the acceleration (gravity direction) information. In addition, the control unit 101 detects the traveling direction of the portable terminal apparatus 1 based on a change in the positional information. In addition, the control unit 101 detects a direction (posture in a horizontal direction) which the portable terminal apparatus 1 faces based on the angular velocity information,

The sensor 106 may detect geomagnetism. In this case, the control unit 101 receives geomagnetism information from the sensor 106, and detects a bearing (posture in north, south, east and west directions and a horizontal direction) which the portable terminal apparatus 1 faces based on the geomagnetism information.

When a destination is present on the left side in the traveling direction of the portable terminal apparatus 1, the control unit 101 generates a vibration moving from the right to the left (see FIGS. 3A and 3B), similarly to the vibration control described with reference to FIG. 9A. Thereby, a user can perceive that a destination is present on the left side in the traveling direction, based on only the direction of the vibration of the portable terminal apparatus 1.

In addition, when the portable terminal apparatus 1 is present in front of the bottom of the stairs, the control unit 101 generates a vibration moving from the bottom to the top (see FIGS. 3A and 3B), similarly to the vibration control described with reference to FIG. 9A. Thereby, a user can perceive that the user has to go up the stairs, based on only the direction of the vibration of the portable terminal apparatus 1.

In addition, when the portable terminal apparatus 1 is present in front of the top of the stairs, the control unit 101 generates a vibration moving from the top to the bottom (see FIGS. 3A and 3B), similarly to the vibration control described with reference to FIG. 9A. Thereby, a user can perceive that the user has to go down the stairs, based on only the direction of the vibration of the portable terminal apparatus 1.

Meanwhile, the control unit 101 may repeatedly generate a vibration. For example, the control unit 101 may repeatedly generate a vibration of a vibration pattern in which the movement from the right to the left is emphasized.

As stated above, in the present embodiment, the control unit 101 generates a vibration indicating the traveling direction from the position of the apparatus in accordance with the posture of the apparatus detected by the sensor 106. For example, the control unit 101 generates a vibration moving from the left to the right in the portable terminal apparatus 1 when a user reaches the point of intersection, and thus guides the user to turn right based on the direction of the vibration. Thereby, the user can perceive that the user has to turn right, based on only the direction of the vibration of the portable terminal apparatus 1. As stated above, the embodiments of the present invention have been described in detail with reference to the accompanying drawings, but a specific configuration is not limited to the embodiments, but includes a design or the like without departing from the gist of the present invention.

For example, the installation positions of the vibration devices 10 are not limited to the above-mentioned embodiments, but each of the vibration devices 10 may be installed at four corners of the portable terminal apparatus 1.

FIG. 11 is a schematic diagram illustrating arrangement positions when the vibration device 10 is disposed at four corners of the portable terminal apparatus 1.

Each of the vibration devices 10 is disposed at each of the four corners of the portable terminal apparatus 1.

In addition, a program for realizing the electronic apparatus described above is recorded in a computer-readable recording medium, and thus executive operations may be performed by causing a computer system to read and execute the program recorded in this recording medium. Meanwhile, the term “computer system” herein may include an OS and hardware such as peripheral devices.

In addition, the “computer system” also includes a homepage providing environment (or a display environment) when a WWW system is used. In addition, the “computer-readable recording medium” means writeable nonvolatile memories such as a flexible disk, a magnetooptic disc, a ROM, and a flash memory, portable mediums such as a CD-ROM, and storage devices such as a hard disk built in the computer system.

Further, the “computer-readable recording medium” means including a medium that holds a program for a certain period of time like a volatile memory (for example, DRAM (Dynamic Random Access Memory)) inside a computer system serving as a server or a client when a program is transmitted through networks such as the Internet or communication lines such as a telephone line.

In addition, the above-mentioned program may be transmitted from a computer system having the program stored in a storage device or the like through a transmission medium, or through transmitted waves in the transmission medium, to another computer system. Here, the “transmission medium” that transmits a program means a medium having a function of transmitting information like networks (communication networks) such as the Internet or communication lines (communication lines) such as a telephone line.

In addition, the above-mentioned program may be a program for realizing a portion of the above-mentioned functions.

Further, the program may be a so-called difference file (difference program) capable of realizing the above-mentioned functions by a combination with a program which is already recorded in a computer system.

What is claimed is:

1. An electronic apparatus comprising:
a plurality of vibrators, disposed at different positions, which generate vibrations; and
a control unit that independently controls frequencies or strengths of the vibrations generated by the plurality of vibrators for each of the vibrators.

2. The electronic apparatus according to claim 1, wherein the control unit causes at least two of the vibrators to vibrate simultaneously, and independently controls the frequency or strength of the vibration generated by each of the vibrators which are caused to vibrate.

3. The electronic apparatus according to claim 1, wherein the control unit changes control of the frequency or strength of the vibration generated by each of the vibrators in accordance with a notification event to a user.

4. The electronic apparatus according to claim 1, wherein the control unit causes one vibrator to vibrate when the notification event to a user is a first notification event, and causes a plurality of the vibrators to vibrate simultaneously when the notification event to a user is a second notification event different from the first notification event.

5. The electronic apparatus according to claim 1, wherein the control unit changes a difference between the frequencies of the vibrators which are caused to vibrate simultaneously, in accordance with the notification event to a user.

6. The electronic apparatus according to claim 1, wherein the control unit causes two or more of the vibrators to vibrate simultaneously, and changes a ratio of strength of the vibration generated by each of the vibrators together with time.

7. The electronic apparatus according to claim 1, wherein the electronic apparatus has a structure having different resonance frequencies depending on location, and
the control unit causes the vibrators to vibrate at a resonance frequency depending on a desired location.

8. The electronic apparatus according to claim 6, wherein when the vibrators having a number smaller than the number of vibrators are caused to vibrate, the control unit changes a combination of the vibrators which are caused to vibrate.

9. The electronic apparatus according to claim 6, further comprising:
an input unit that inputs a vibration pattern, indicating a vibrator which is caused to vibrate and frequency or strength at which the vibrator is caused to vibrate, for each notification event to a user; and
a storage unit that stores the vibration pattern which is input by the input unit in association with the notification event to a user.

10. The electronic apparatus according to claim 6, wherein the vibrator is a linear vibration actuator.

11. The electronic apparatus according to claim 6, further comprising a sensor that detects a position and a posture of the apparatus,
wherein the control unit generates a vibration indicating a traveling direction from the position of the apparatus in accordance with the posture detected by the sensor.

12. A vibrating method comprising a step of causing an electronic apparatus including a plurality of vibrators, disposed at different positions, which generate vibrations to independently control frequencies or strengths of the vibrations generated by the plurality of vibrators for each of the vibrators.
